(19) United States
(12) Patent Application Publication
(10) Pub. No.: US 2022/0371243 A1
(43) Pub. Date: Nov. 24, 2022

(54) DECORATED MOLDING ARTICLE AND METHOD OF FABRICATING THE SAME

(71) Applicant: Jin Ya Dian Technology Co.,Ltd., Taoyuan City (TW)

(72) Inventor: Kuo-Liang Ying, Taoyuan City (TW)

(73) Assignee: Jin Ya Dian Technology Co.,Ltd., Taoyuan City (TW)

(21) Appl. No.: 17/355,183

(22) Filed: Jun. 23, 2021

(30) Foreign Application Priority Data
May 21, 2021 (TW) 110118368

(51) Int. Cl. B29C 45/16; B32B 3/30; B32B 7/02

(52) U.S. Cl. CPC B29C 45/1679; B32B 3/30; B32B 7/02; B32B 2451/00; B32B 2605/00; B29L 2031/3005

(57) ABSTRACT

A decorated molding article includes a workpiece and a composite layer structure. The composite layer structure is attached to an outer surface of the workpiece through an adhesive layer. The composite layer structure at least includes: a substrate having a first surface and a second surface opposite to each other; an optical effect layer disposed on the first surface of the substrate; and a decorative layer disposed between the first surface of the substrate and the optical effect layer. The decorative layer formed by a printing method has a thickness less than a thickness of the optical effect layer formed by a coating method, and the optical effect layer and the decorative layer each includes a protective material, an ink material, and an adhesive material. In such embodiment, the all-in-one coating material may be formed on the substrate by the coating method or the printing method to form the optical effect layer and the decorative layer with protective, color, and adhesive effects.

### CROSS-REFERENCE TO RELATED APPLICATION

This application claims the priority benefit of Taiwan application serial no. 110118368, filed on May 21, 2021. The entirety of the above-mentioned patent application is hereby incorporated by reference herein and made a part of this specification.

### BACKGROUND

### 1. Technical Field

The disclosure relates to a decorated molding article and its fabricating method.

### 2. Description of Related Art

Generally speaking, decorations such as patterns or texts on the surface of an object casing are mainly formed through spraying or printing processes in order to present a specific visual effect and add variability of the appearance of the object. The traditional forming method is to apply the hardened layer to the surface of the casing by spraying after the casing of the related product is completed. This method is complicated, has a poor yield, and causes contamination of organic solvent gases, which leads to many pollution problems. On the other hand, because the spraying process has the disadvantages of time-consuming, complicated process, and low thickness uniformity, it is not suitable for mass production.

In order to solve the aforementioned problems, a variety of specific decoration processes using decorative films have been proposed. For example, in-mold decoration (IMD) or out mold decoration (OMD) has become another choice for forming patterns and texts on the object surface.

At present, the commonly used polymer substrate materials in in-mold decoration include polycarbonate (PC), polymethyl methacrylate, also known as poly(methyl methacrylate) (PMMA), polyethylene terephthalate (PET), and acrylonitrile butadiene styrene (ABS). However, the hardness of the substrate composed of PC and ABS is low, which makes the surface of the substrate prone to damage. Therefore, most of the substrate surface is coated with a protective layer to increase the hardness and scratch resistance of the substrate surface. On the other hand, the substrate composed of PMMA has high hardness, but it is easy to crack during forming, so the hot pressing process cannot be easily performed.

### SUMMARY

The disclosure provides a method for fabricating decorated molding article, including: providing a coating, the coating at least includes: a protective material, an ink materials, and an adhesive materials uniformly mixed together; forming the coating on a substrate by a coating method or a printing method; and performing a first curing step to form a composite layer structure, wherein the composite layer structure includes an optical effect layer disposed on the substrate.

In one embodiment of the disclosure, the protective material includes polymethyl methacrylate, aliphatic polyurethane acrylate, epoxy acrylate, polyester polyol, or a combination thereof; the ink material includes polyurethane; and the adhering material includes thermoplastic polyurethane, aromatic urethane acrylate or a combination thereof.

In one embodiment of the disclosure, the coating further includes: a heat-resistant material, a solvent, and a hardener.

In one embodiment of the disclosure, after the first curing step, the method further includes: performing an in-mold decoration or an out mold decoration on the composite layer structure, such that the composite layer structure is attached to an outer surface of a workpiece through an adhesive layer so as to form a decorated molding article; and performing a second curing step so as to increase the hardness of the optical effect layer.

In one embodiment of the disclosure, a step of performing the in-mold decoration on the composite layer structure includes: disposing the composite layer structure in an in-mold decoration mold with a mold molding concavity, wherein the composite layer structure covers at least a part of a surface of the mold molding concavity; pouring a molding material into the in-mold decoration mold, such that the molding material and the composite layer structure are combined with each other; cooling the molding material; cooling the molding material; and taking the decorated molding article out of the in-mold decoration mold.

In one embodiment of the disclosure, a step of performing the out mold decoration on the composite layer structure includes: providing the workpiece; placing the workpiece and the composite layer structure in a fixture; and performing a high-pressure decorative molding process, such that the composite layer structure is attached to the outer surface of the workpiece through the adhesive layer.

The disclosure provides a method for fabricating decorated molding article, including: providing a substrate having a first surface and a second surface opposite to each other; forming a first coating on the first surface of the substrate using a printing method; forming a second coating on the first coating using a coating method; and performing a first curing step to form a composite layer structure, wherein the composite layer structure at least includes: the substrate; a first optical effect layer, disposed on the first surface of the substrate; and a first decorative layer, disposed between the first surface of the substrate and the first optical effect layer, wherein a thickness of the first decorative layer is smaller than a thickness of the first optical effect layer.

In one embodiment of the disclosure, the first coating and the second coating each include a protective material, an ink material, and an adhesive material uniformly mixed together.

In one embodiment of the disclosure, the protective material includes polymethyl methacrylate, aliphatic polyurethane acrylate, epoxy acrylate, polyester polyol or a combination thereof; the ink material includes polyurethane; and the adhering material includes thermoplastic polyurethane, aromatic urethane acrylate or a combination thereof.

In one embodiment of the disclosure, the method of fabricating decorated molding article further includes: performing a first laser engraving process on the composite layer structure so as to form a first groove in the first optical effect layer.

In one embodiment of the disclosure, the method of fabricating decorated molding article further includes: forming a third coating on the second surface of the substrate using the printing method; and forming a fourth coating on the third coating using the coating method, wherein after the first curing step, the composite layer structure further includes: a second optical effect layer, disposed on the second surface of the substrate; and a second decorative layer, disposed between the second surface of the substrate and the second optical effect layer, wherein a thickness of the second decorative layer is smaller than a thickness of the second optical effect layer.

In one embodiment of the disclosure, the third coating and the fourth coating each include: a protective material, an ink material, and an adhesive material uniformly mixed together, wherein the protective material includes polymethyl methacrylate, aliphatic polyurethane acrylate, epoxy acrylate, polyester polyol or a combination thereof; the ink material includes polyurethane; and the adhering material includes thermoplastic polyurethane, aromatic urethane acrylate or a combination thereof.

In one embodiment of the disclosure, the method of fabricating decorated molding article further includes: performing a second laser engraving process on the composite layer structure so as to form a second groove in the second optical effect layer.

In one embodiment of the disclosure, after performing the above-mentioned first curing step, it further includes: after performing the first curing step, the method further including: performing an in-mold decoration or an out mold decoration on the composite layer structure, such that the composite layer structure is attached to an outer surface of a workpiece through an adhesive layer, so as to form a decorated molding article; and performing a second curing step, so as to increase a hardness of the first optical effect layer and the second optical effect layer.

The disclosure provides a decorated molding article, including: a workpiece; and a composite layer structure, attached to an outer surface of a workpiece through an adhesive layer, wherein the composite layer structure includes at least: a substrate, having a first surface and a second surface opposite to each other; a first optical effect layer, disposed on the first surface of the substrate; and a first decorative layer, disposed between the first surface of the substrate and the first optical effect layer, wherein a thickness of the first decorative layer is smaller than a thickness of the first optical effect layer, and the first optical effect layer and the first decorative layer each include a protective material, an ink material, and an adhesive material.

In one embodiment of the disclosure, the protective material includes polymethyl methacrylate, aliphatic polyurethane acrylate, epoxy acrylate, polyester polyol or a combination thereof; the ink material includes polyurethane; and the adhering material includes thermoplastic polyurethane, aromatic urethane acrylate or a combination thereof.

In one embodiment of the disclosure, the composite layer structure further includes: a second optical effect layer, disposed on the second surface of the substrate; and a second decorative layer, disposed between the second surface of the substrate and the second optical effect layer, wherein a thickness of the second decorative layer is smaller than a thickness of the second optical effect layer.

In one embodiment of the disclosure, the composite layer structure further includes: a first groove, extending from a surface of the first optical effect layer to a direction of the substrate; and a second groove, extending from a surface of the second optical effect layer to a direction of the substrate.

In one embodiment of the disclosure, a material of the outer surface of the workpiece includes plastic, resin, metal, carbon fiber, glass, or a combination thereof.

In one embodiment of the disclosure, the workpiece includes an electronic device casing or component and a vehicle casing or component, or a combination thereof, wherein the vehicle casing or component includes a car interior, a car exterior, a car sign, a car dashboard, a smart key, and an engine start button, or a combination thereof.

Based on the above, the disclosure may use a coating method or a printing method to form an all-in-one coating on a substrate and perform a curing step, thereby forming an optical effect layer with a protective effect, a color effect, and an adhering effect. Therefore, the disclosure may effectively simplify the fabricating steps, reduce the fabricating cost and prevent the pollution problem caused by the adhesive film.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic flow chart of a method of fabricating decorated molding article according to an embodiment of the disclosure.

FIG. 2 is a schematic cross-sectional view of a composite layer structure according to an embodiment of the disclosure.

FIG. 3 is a schematic cross-sectional view of a decorated molding article according to a first embodiment of the disclosure.

FIG. 4A is a schematic cross-sectional view of a decorated molding article according to a second embodiment of the disclosure.

FIG. 4B is a schematic cross-sectional view of a decorated molding article according to a third embodiment of the disclosure.

FIG. 5A is a schematic cross-sectional view of a decorated molding article according to a fourth embodiment of the disclosure.

FIG. 5B is a schematic cross-sectional view of a decorated molding article according to a fifth embodiment of the disclosure.

FIG. 6 is a schematic cross-sectional view of a decorated molding article according to a sixth embodiment of the disclosure.

FIG. 7 is a schematic cross-sectional view of a decorated molding article according to a seventh embodiment of the disclosure.

FIG. 8 is a schematic flowchart of an in-mold decoration according to an embodiment of the disclosure.

FIG. 9 is a schematic flow chart of an out mold decoration according to an embodiment of the disclosure.

### DESCRIPTION OF THE EMBODIMENTS

Hereinafter, the disclosure will be described more fully with reference to the accompanying drawings. However, the disclosure may be practiced in many different forms and is not limited to the embodiments described in the text. The direction terms mentioned in the following embodiments, such as “upper”, “lower”, etc., are only directions referring to the attached drawings. Therefore, the direction terms used are used for detailed description, not for limiting the disclosure. In addition, the thickness of layers and regions in the drawings will be exaggerated for clarity. The same or similar element numbers indicate the same or similar elements, and the following paragraphs will not repeat them one by one.

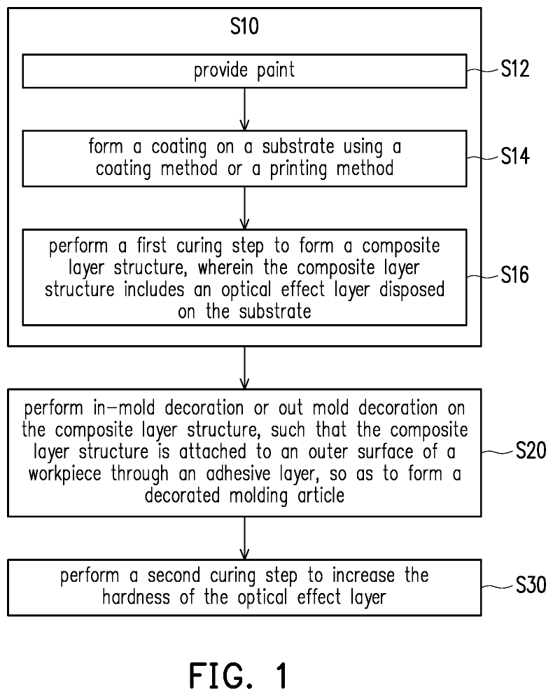

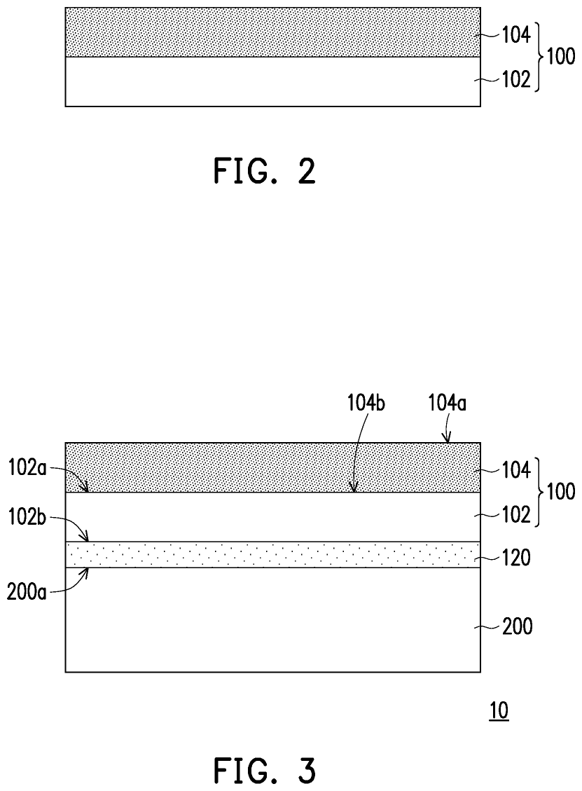

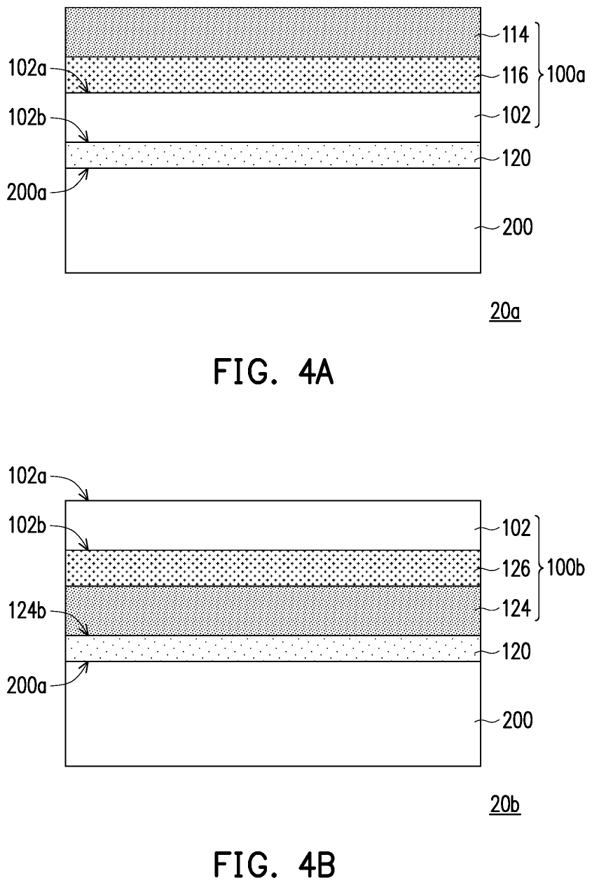

FIG. 1 is a schematic flow chart of a method of fabricating decorated molding article according to an embodiment of the disclosure. FIG. 2 is a schematic cross-sectional view of a composite layer structure according to an embodiment of the disclosure. FIG. 3 is a schematic cross-sectional view of a decorated molding article according to a first embodiment of the disclosure.

Referring to FIG. 1, an embodiment of the disclosure provides a method for fabricating decorated molding article 10 (shown in FIG. 3) as follows. Proceed step S10 to form a composite layer structure 100 (as shown in FIG. 2). Specifically, forming the composite layer structure 100 includes: proceed step S12 to provide a coating. The coating at least includes: a protective materials, an ink materials and an adhesive material uniformly mixed together. In one embodiment, the protective material may include polymethylmethacrylate (PMMA), aliphatic urethane diacrylate, epoxy acrylate (EA), polyester polyol, or a combination. The ink material may include polyurethane (PU) and similar materials. The adhesive material may include thermoplastic polyurethane (TPU), aromatic urethane diacrylate, or a combination thereof. Moreover, the coating further includes: a heat-resistant material, a solvent and a hardener. In one embodiment, the heat-resistant material may include polycarbonate (PC) and similar materials. The solvent may include ethyl acetate, methyl ethyl ketone, toluene, xylene or a combination thereof. The hardener may include polyisocyanate and similar materials. However, the disclosure is not limited thereto. In other embodiments, the coating may also include other additives, such as matting powder, pearl powder, etc., such that a subsequently formed optical effect layer 104 (as shown in FIG. 2) has different visual effects such as matting and pear luster.

Then, proceed step S14 to form the coating on a substrate 102 (as shown in FIG. 2) using a coating method or a printing method. In one embodiment, the material of the substrate 102 includes acrylonitrile-butadiene-styrene copolymer (ABS), polycarbonate (PC), polymethyl methacrylate (PMMA), or a combination thereof, and the forming method includes extrusion molding method and the like. For example, the ABS solid plastic may be heated, melted, extruded, and cooled to form the ABS substrate 102 by an extrusion molding method. Moreover, the ABS solid plastic may be mixed with color masterbatch, pigments, pearl powder and related additives to form a mixture. Then, an extrusion molding method is used to extrude the mixture to form another ABS substrate, such that the ABS substrate has visual effects such as color, pearly luster, bright surface, mirroring surface, matting surface, and the like.

Specifically, the coating method is to distribute the coating material in a coating device, and uniformly coat the coating material on the substrate 102 through a coating head of the coating device. In one embodiment, an opening of the coating head may be flat, such that the coating applied on the substrate 102 has a bright surface effect. In another embodiment, an opening of a coating head may have multiple microstructures (for example, micro-dents), such that the coating applied on the substrate 102 has a matting effect. In an alternative embodiment, an opening of a coating head may have multiple concave-convex structures, such that the coating applied on the substrate 102 has a hairline effect. On the other hand, the printing method may include a gravure printing method, a screen printing method, an offset printing method, a reverse printing method, or an inkjet printing method. The printing method. Compared with the coating method, the printing method may form a thinner film layer.

After that, proceed step S16 to perform a first curing step to form a composite layer structure 100. As shown in FIG. 2, the composite layer structure 100 includes a substrate 102 and the optical effect layer 104 disposed on the substrate 102. In one embodiment, the first curing step may include a thermal curing step, an ultraviolet (UV) curing step, a combination thereof, or other suitable curing steps. The first curing step may cause the adhesive material to undergo a cross-linking reaction and be adhered to the substrate 102. In the present embodiment, the coating may be regarded as an all-in-one coating, which allows the cured optical effect layer 104 to have a protective effect, a color effect, and an adhering effect at the same time. Compared with the steps in the prior art that need to purchase a protective layer and form an adhesive film structure through a printing and adhering process, the disclosure may effectively simplify the fabricating steps, reduce the fabricating cost and prevent the contamination problem caused by the adhesive film.

After forming the composite layer structure 100, proceed step S20 to perform in-mold decoration or out mold decoration on the composite layer structure 100, such that the composite layer structure 100 is attached to an outer surface 200a of a workpiece 200 through the adhesive layer 120 to form the decorated molding article 10, as shown in FIG. 3. The steps of the in-mold decoration or the out mold decoration will be described in detail in the subsequent paragraphs, and will not be described in detail here. In one embodiment, the substrate 102 has a first surface 102a and a second surface 102b opposite to each other. As shown in FIG. 3, the second surface 102b of the substrate 102 contacts an adhesive layer 120, the first surface 102a of the substrate 102 contacts the bottom surface 104b of the optical effect layer 104, and the top surface 104a of the optical effect layer 104 is exposed upward. In one embodiment, the adhesive layer 120 may be, for example, a hot melt adhesive, a UV curable adhesive, a light curable adhesive, or a combination thereof. For example, the material of the adhesive layer 120 may include polyacrylate, polymethacrylate, polystyrene, polycarbonate, polyurethane, polyester, polyamide, epoxy resin, ethylene vinyl acetate copolymer (EVA) or thermoplastic elastomer or copolymers or mixtures of the above materials or at least one material in the composite.

After the decorated molding article 10 is formed, step S30 may be proceeded to perform a second curing step so as to increase the hardness of the optical effect layer 104. In one embodiment, the second curing step may include a thermal curing step, an ultraviolet (UV) curing step, a combination thereof, or other suitable curing steps. In the present embodiment, the first curing step is different from the second curing step. For example, the first curing step may be a thermal curing step, and the second curing step may be a UV curing step; and vice versa. In an alternative embodiment, when the first curing step and the second curing step are both thermal curing steps, a curing temperature of the second curing step may be higher than a curing temperature of the first curing step. It is worth noting that the second curing step may cause the protective material to undergo a cross-linking reaction so as to increase the hardness of the top surface 104a of the optical effect layer 104, thereby enhancing the protective effect. That is to say, when the in-mold decoration or the out mold decoration (i.e. step S20) is performed, the optical effect layer 104 is not completely cured yet and has ductility, and then is completely attached to the outer surface 200a of the workpiece 200. After the second curing step (i.e. step S30) is performed, the optical effect layer 104 is completely cured and has a complete protective effect. In the present embodiment, the hardness of the optical effect layer 104 may have a gradient change. Specifically, the hardness of the optical effect layer 104 may increase from a bottom surface 104b toward the top surface 104a. In other words, a hardness of the top surface 104a of the optical effect layer 104 may be greater than a hardness of the bottom surface 104b of the optical effect layer 104.

FIG. 4A is a schematic cross-sectional view of a decorated molding article according to a second embodiment of the disclosure.

Referring to FIG. 4A, a decorated molding article 20a of the second embodiment is similar to the decorated molding article 10 of the first embodiment. The difference between the above two is that a composite layer structure 100a of the decorated molding article 20a includes: the substrate 102, an optical effect layer 114, and a decorative layer 116. Specifically, the optical effect layer 114 is disposed on the first surface 102a of the substrate 102, and the decorative layer 116 is disposed between the first surface 102a of the substrate 102 and the optical effect layer 114. In one embodiment, the method for forming the composite layer structure 100a includes: forming the first coating on the first surface 102a of the substrate 102 by a printing method; forming the second coating on the first coating by a coating method; and perform the first curing step. In this case, the cured first coating is formed as the decorative layer 116, and the cured second coating is formed as the optical effect layer 114. In the present embodiment, a thickness of the decorative layer 116 may be less than a thickness of the optical effect layer 114. For example, a thickness of the decorative layer 116 may be between 1 μm and 5 μm, such as 1 μm; and the thickness of the optical effect layer 114 may be between 1 μm and 20 μm, such as 10 μm.

In one embodiment, the first coating and the second coating each include a protective material, an ink material, and an adhesive material uniformly mixed together. The protective material may include polymethyl methacrylate, aliphatic urethane acrylate, epoxy acrylate, polyester polyol or a combination thereof. The ink material may include polyurethane and similar materials. The adhesive material may include thermoplastic polyurethane, aromatic urethane acrylate or a combination thereof. Moreover, the first coating and the second coating each include: a heat-resistant material, a solvent, and a hardener. In one embodiment, the heat-resistant material may include polycarbonate and similar materials; the solvent may include ethyl acetate, methyl ethyl ketone, toluene, xylene, or a combination thereof. The hardener may include materials such as polyisocyanate. However, the disclosure is not limited thereto. In other embodiments, the first coating and the second coating may each include other additives, such as matting powder, pearl powder, etc., such that the optical effect layer 114 and the decorative layer 116 has different visual effects such as matting and pearly luster.

In the present embodiment, the decorative layer 116 may be printed in a single time or multiple times to present different decorative patterns such as wood grain and geometric patterns. The optical effect layer 114 disposed on the decorative layer 116 may have different visual effects such as transparency, monochromatic, matting, pearly luster, and the like to superimpose with the decorative layer 116, thereby enriching the visual effects of the user or viewer. For example, the decorative layer 116 may have a wood grain pattern, and the optical effect layer 114 may be matting silver, such that the composite layer structure 100a exhibits a wood grain pattern with matting silver.

FIG. 4B is a schematic cross-sectional view of a decorated molding article according to a third embodiment of the disclosure.

Referring to FIG. 4B, a decorated molding article 20b of the third embodiment is similar to the decorated molding article 20a of the second embodiment. The difference between the above two is that: the decorated molding article 20b flips the composite layer structure 100a upside down to form a composite layer structure 100b. Specifically, the composite layer structure 100b of the third embodiment includes: the substrate 102, an optical effect layer 124, and a decorative layer 126. The optical effect layer 124 is disposed on the second surface 102b of the substrate 102, and the decorative layer 126 is disposed between the second surface 102b of the substrate 102 and the optical effect layer 124. A bottom surface 124b of the optical effect layer 124 contacts the adhesive layer 120 and is attached to the outer surface 200a of the workpiece 200, while the first surface 102a of the substrate 102 is exposed upward. Since the materials and forming methods of the optical effect layer 124 and the decorative layer 126 are the same as the materials and forming methods of the optical effect layer 114 and the decorative layer 116, they will not be repeated here. In one embodiment, a thickness of the decorative layer 126 formed by the printing method may be smaller than a thickness of the optical effect layer 124 formed by the coating method.

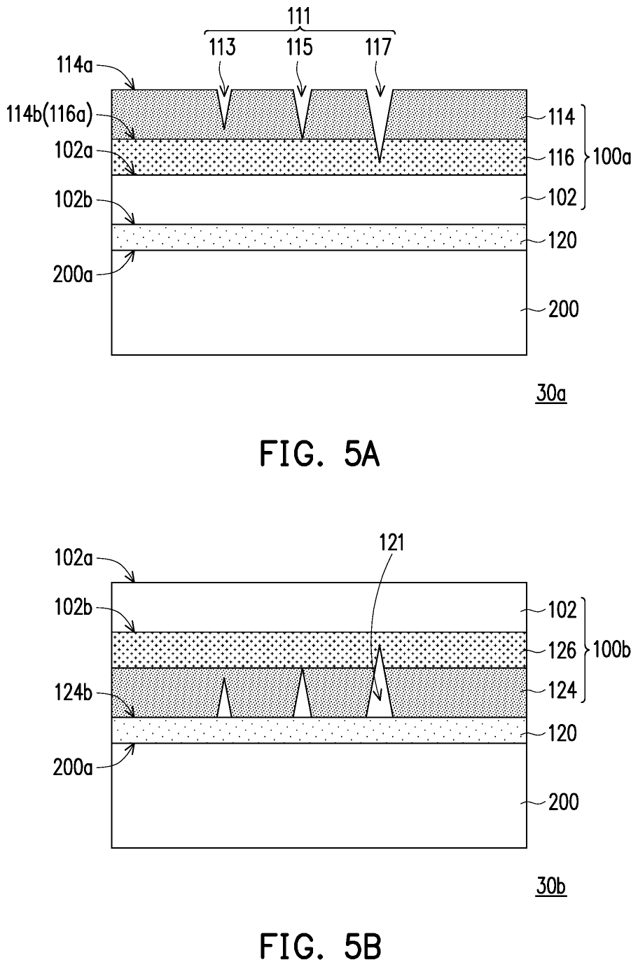

FIG. 5A is a schematic cross-sectional view of a decorated molding article according to a fourth embodiment of the disclosure.

Referring to FIG. 5A, a decorated molding article 30a of the fourth embodiment is similar to the decorated molding article 20a of the second embodiment. The difference between the above two is that the decorated molding article 30a further performs a laser engraving process on the composite layer structure 100a to form multiple grooves 111 in the optical effect layer 114, thereby increasing the user's visual and tactile experience. Specifically, the groove 111 may extend from a top surface 114a of the optical effect layer 114 toward the substrate 102 and be exposed to the external environment. Although the groove 111 shown in FIG. 5A has a tapered profile, the disclosure is not limited thereto. In other embodiments, the groove 111 may be an arc-shaped contour, a rectangular contour, or various contours formed by a laser engraving process. It is worth noting that, since the optical effect layer 114 and the decorative layer 116 of the present embodiment have protective effects, color effects, and adhering effects at the same time. Therefore, even after the laser engraving process, the optical effect layer 114 and the decorative layer 116 may still protect the substrate 102 from damage, thereby avoiding peeling from the workpiece 200. In other words, the composite layer structure 100a of the disclosure does not need to form an additional protective layer (such as gold oil) on the optical effect layer 114 after the laser engraving process to protect the substrate 102 and the workpiece 200 underneath, thereby reducing the fabricating cost.

In one embodiment, the groove 111 may include a groove 113, a groove 115, and a groove 117 of different depths. Specifically, the bottom surface of the groove 113 may be located between the top surface 114a and the bottom surface 114b of the optical effect layer 114. The bottom surface of the groove 115 may expose a top surface 116a of the decorative layer 116. The bottom surface of the groove 117 may extend into the decorative layer 116, but the first surface 102a of the substrate 102 is not exposed. Although FIG. 5A illustrates the multiple grooves 111 of different depths, the disclosure is not limited thereto. In other embodiments, the multiple grooves 111 may also have the same depth.

FIG. 5B is a schematic cross-sectional view of a decorated molding article according to a fifth embodiment of the disclosure.

Referring to FIG. 5B, a decorated molding article 30b of the fifth embodiment is similar to the decorated molding article 30a of the fourth embodiment. The difference between the above two is that: the decorated molding article 30b flips the composite layer structure 100a upside down to form the composite layer structure 100b. Specifically, the composite layer structure 100b of the fifth embodiment includes: the substrate 102, the optical effect layer 124, and the decorative layer 126. The bottom surface 124b of the optical effect layer 124 contacts the adhesive layer 120 and is attached to the outer surface 200a of the workpiece 200, while the first surface 102a of the substrate 102 is exposed upward. In the present embodiment, a groove 121 may extend from the bottom surface 124b of the optical effect layer 124 toward the substrate 102, such that the groove 121 is buried between the adhesive layer 120 and the substrate 102.

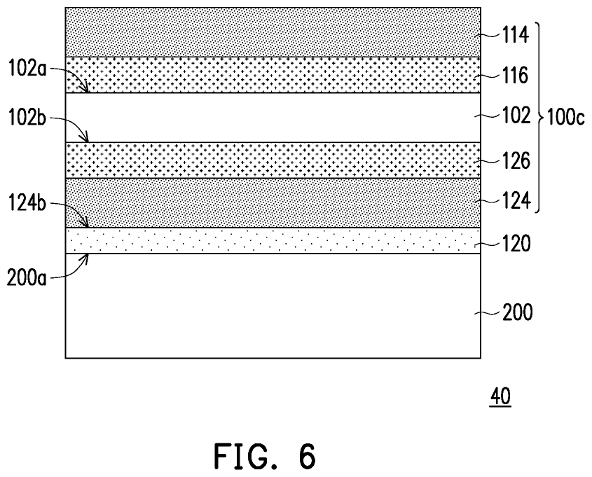

FIG. 6 is a schematic cross-sectional view of a decorated molding article according to a sixth embodiment of the disclosure.

Referring to FIG. 6, a decorated molding article 40 of the sixth embodiment is similar to the decorated molding article 20b of the third embodiment. The difference between the above two is that a composite layer structure 100c of the decorated molding article 40 of the sixth embodiment further includes: forming an optical effect layer 114 and a decorative layer 116 on the first surface 102a of the substrate 102. That is, the optical effect layers 114, 124 and the decorative layers 116, 126 are respectively formed on the upper surface 102a and the lower surface 102b of the substrate 102 of the composite layer structure 100c, thereby increasing the visual effect of the user or the viewer.

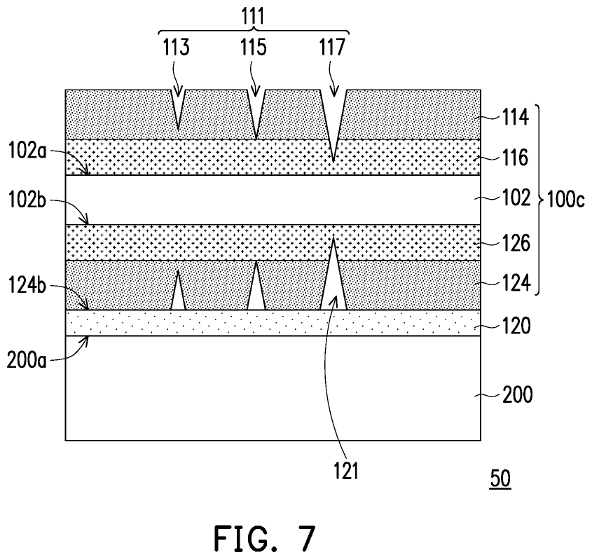

FIG. 7 is a schematic cross-sectional view of a decorated molding article according to a seventh embodiment of the disclosure.

Referring to FIG. 7, a decorated molding article 50 of the seventh embodiment is similar to the decorated molding article 40 of the sixth embodiment. The difference between the above two is that for the decorated molding article 50, a laser engraving process is further performed on the composite layer structure 100c so as to form the multiple grooves 111 and 121 in the optical effect layers 114 and 124, respectively. In one embodiment, a first laser engraving process is performed to form the first groove 111 in the optical effect layer 114. Moreover, a second laser engraving process is performed to form a second groove 121 different from the first groove 111 in the optical effect layer 124. In an alternative embodiment, the first groove 111 may be formed only in the optical effect layer 114, or the second groove 121 may be formed only in the optical effect layer 124.

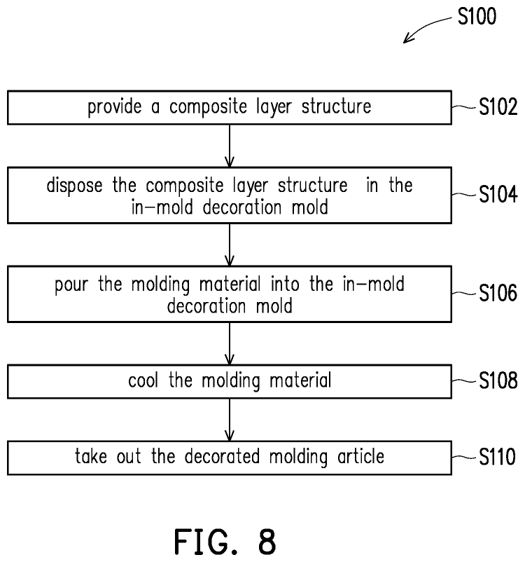

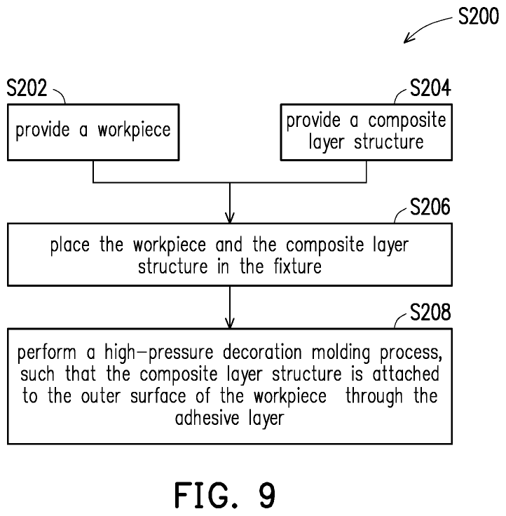

FIG. 8 is a schematic flowchart of an in-mold decoration according to an embodiment of the disclosure. FIG. 9 is a schematic flow chart of an out mold decoration according to an embodiment of the disclosure.

Please refer to FIG. 8, a step process of in-mold decoration S100 is shown below. First, proceed step S102 to provide a composite layer structure. The composite layer structure may be, for example, the composite layer structure 100 or other composite layer structures 100a, 100b, 100c (hereinafter referred to as the composite layer structure 100). The composition of the composite layer structure 100 has been explained in the above paragraphs, and will not be repeated here.

Next, proceed step S104 to dispose the composite layer structure 100 in the in-mold decoration mold. In detail, the in-mold decoration mold includes a hollow mold molding concavity. The molding concavity has a surface. After that, the composite layer structure 100 is attached to the surface of the mold molding concavity such that the composite layer structure 100 covers at least a part of the surface of the mold molding concavity. In an alternative embodiment, before proceeding step S106, heating pre-forming may be selectively performed and the excess composite layer structure may be removed by die cutting, laser cutting, or water jet cutting.

Then, proceed step S106 to pour the molding material into the molding concavity of the in-mold decoration mold, such that the molding material and the composite layer structure 100 are combined with each other. In one embodiment, the molding material may be a suitable molding material such as plastic material, resin material, metal material, carbon fiber material, glass, etc.

After that, proceed step S108 to cool the molding material to form the workpiece 200. The workpiece 200 depends on the application of the decorated molding article of the disclosure, which may be an electronic device casing or component, a vehicle casing or component, or a combination thereof. For example, workpiece 200 may be, for example, a mobile phone, a digital camera, a personal digital assistant (PDA), a notebook computer, a desktop computer, a touch panel, a TV, a satellite positioning system (GPS), a car monitor, a navigation, a displays, a digital photo frame, a DVD player, an automotive interior trim panel (such as a handles, a trim strip, a touch front bumper, etc.), an automotive exterior decorative panel (such as an exterior handle, a back door decorative strip, etc.), a car dashboard, a car logo, an intelligent key (I-key), an engine start button, a clock, a radio, a toy, a watch, or other enclosures or components used in electronic products that require electricity. However, the disclosure does not limit the shape and structure of the workpiece 200, as long as the shape and structure of the workpiece 200 may be completed by the in-mold decoration are within the scope of the disclosure.

Next, proceed step S110 to take out the decorated molding article from the in-mold decoration mold. The resulting decorated molding articles 10, 20a, 20b, 30a, 30b, 40, and 50 have been described in detail in FIGS. 3, 4A, 4B, 5A, 5B, 6, and 7 above. Go into details again.

On the other hand, decorated molding articles may also be fabricated by out mold decoration. With reference to FIG. 9, the step process of out mold decoration technology S200 is as follows. First, proceed step S202 to provide the workpiece 200. In one embodiment, the workpiece 200 depends on the application of the decorated molding article of the disclosure, and it may be an electronic device casing or component, a vehicle casing or component, or a combination thereof. In an alternative embodiment, the material of the outer surface 200a of the workpiece 200 may be plastic, resin, metal, carbon fiber, glass, or other shaped various casing materials. For example, the workpiece 200 may be a workpiece that undergoes appropriate pre-treatment processes for desired characteristics. For example, when the material of the workpiece is plastic, a plastic workpiece (such as a plastic casing, etc.) may be obtained by an injection molding mold through an injection molding process. Alternatively, when the material of the workpiece is metal, the metal may be surface treated first so as to obtain a metal workpiece (such as a metal chassis, etc.).

Next, proceed step S204 to provide a composite layer structure. The composite layer structure may be, for example, the composite layer structure 100 shown in FIG. 3 or other composite layer structures 100a, 100b, and 100c (hereinafter referred to as composite layer structure 100). The composition of the composite layer structure 100 has been explained in the above paragraphs, and will not be repeated here.

After that, proceed step S206 to place the workpiece 200 and the composite layer structure 100 in the fixture. It is explained here that before proceeding step S206, the fixture may be selectively designed and prepared according to the requirements of the final product.

Then, proceed step S208 to perform a high-pressure decoration molding process, such that the composite layer structure 100 is attached to the outer surface 200a of the workpiece 200 through the adhesive layer 120. In detail, the high-pressure decorative molding process, for example, first performs a heating and softening step on the composite layer structure 100. In one embodiment, the temperature of the heating and softening step may be between 80° C. and 150° C.; the time of the heating and softening step may be between 30 seconds and 180 seconds. Next, the composite layer structure 100 is brought into contact with the workpiece 200, and a pressurizing step is performed. After that, the composite layer structure 100 is subjected to a high-pressure vacuum forming step, such that the composite layer structure 100 is attached to the workpiece 200. Finally, the remaining composite layer structure may be selectively removed by die cutting, laser cutting or water jet cutting. In short, in the present embodiment, the composite layer structure 100 may be tightly adhered to a part of the outer surface 200a of the workpiece 200 by using the external decoration.

In summary, in the disclosure, the coating method or printing method may be used so as to form an all-in-one coating on a substrate and perform a curing step thereon, thereby forming an optical effect layer with a protective effect, a color effect, and an adhering effect. Therefore, the disclosure may effectively simplify the fabricating steps, reduce the fabricating cost, and prevent the contamination problem caused by the adhesive film.

Furthermore, in the disclosure a laser engraving process may also be performed, so as to form multiple grooves in the optical effect layer, thereby increasing the user's tactile experience. In the present embodiment, the optical effect layer of the disclosure still has a protective effect after the laser engraving process, and the substrate can be protected from damage and from peeling off the workpiece without forming an additional protective layer.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method of fabricating decorated molding article, comprising:
providing a coating, wherein the coating at least comprises: a protective material, an ink materials, and an adhesive material uniformly mixed together;
forming the coating on a substrate by a coating method or a printing method; and
performing a first curing step to form a composite layer structure, wherein the composite layer structure comprises an optical effect layer disposed on the substrate.

2. The method of fabricating decorated molding article as described in claim 1, wherein the protective material comprises polymethyl methacrylate, aliphatic polyurethane acrylate, epoxy acrylate, polyester polyol, or a combination thereof; the ink material comprises polyurethane; and the adhering material comprises thermoplastic polyurethane, aromatic urethane acrylate or a combination thereof.

3. The method for fabricating decorated molding article as described in claim 1, wherein the coating further comprises: a heat-resistant material, a solvent, and a hardener.

4. The method for fabricating decorated molding article as described in claim 1, wherein after the first curing step, the method further comprises:
performing an in-mold decoration or an out mold decoration on the composite layer structure, such that the composite layer structure is attached to an outer surface of a workpiece through an adhesive layer so as to form a decorated molding article; and
performing a second curing step so as to increase the hardness of the optical effect layer.

5. The method for fabricating decorated molding article as described in claim 4, wherein a step of performing the in-mold decoration on the composite layer structure comprises:
disposing the composite layer structure in an in-mold decoration mold with a mold molding concavity, wherein the composite layer structure covers at least a part of a surface of the mold molding concavity;
pouring a molding material into the in-mold decoration mold, such that the molding material and the composite layer structure are combined with each other;
cooling the molding material; and
taking the decorated molding article out of the in-mold decoration mold.

6. The method for fabricating decorated molding article as described in claim 4, wherein a step of performing the out mold decoration on the composite layer structure comprises:
providing the workpiece;
placing the workpiece and the composite layer structure in a fixture; and
performing a high-pressure decorative molding process, such that the composite layer structure is attached to the outer surface of the workpiece through the adhesive layer.

7. A method of fabricating decorated molding article, comprising:
providing a substrate having a first surface and a second surface opposite to each other;
forming a first coating on the first surface of the substrate using a printing method;
forming a second coating on the first coating using a coating method; and
performing a first curing step to form a composite layer structure, wherein the composite layer structure at least comprises:
the substrate;
a first optical effect layer, disposed on the first surface of the substrate; and
a first decorative layer, disposed between the first surface of the substrate and the first optical effect layer, wherein a thickness of the first decorative layer is smaller than a thickness of the first optical effect layer.

8. The method for fabricating decorated molding article as described in claim 7, wherein the first coating and the second coating each comprise a protective material, an ink material, and an adhesive material uniformly mixed together.

9. The method of fabricating decorated molding article as described in claim 8, wherein the protective material comprises polymethyl methacrylate, aliphatic polyurethane acrylate, epoxy acrylate, polyester polyol or a combination thereof; the ink material comprises polyurethane; and the adhering material comprises thermoplastic polyurethane, aromatic urethane acrylate or a combination thereof.

10. The method of fabricating decorated molding article as described in claim 7, further comprising: performing a first laser engraving process on the composite layer structure so as to form a first groove in the first optical effect layer.

11. The method of fabricating decorated molding article as described in claim 7, further comprising:
forming a third coating on the second surface of the substrate using the printing method; and
forming a fourth coating on the third coating using the coating method, wherein after the first curing step, the composite layer structure further comprises:
a second optical effect layer, disposed on the second surface of the substrate; and
a second decorative layer, disposed between the second surface of the substrate and the second optical effect layer, wherein a thickness of the second decorative layer is smaller than a thickness of the second optical effect layer.

12. The method of fabricating decorated molding article as described in claim 11, wherein the third coating and the fourth coating each comprise: a protective material, an ink material, and an adhesive material uniformly mixed together, wherein the protective material comprises polymethyl methacrylate, aliphatic polyurethane acrylate, epoxy acrylate, polyester polyol or a combination thereof; the ink material comprises polyurethane; and the adhering material comprises thermoplastic polyurethane, aromatic urethane acrylate or a combination thereof.

13. As described in claim 11, the method for fabricating decorated molding article, further comprising: performing a second laser engraving process on the composite layer structure so as to form a second groove in the second optical effect layer.

14. The method of fabricating decorated molding article as described in claim 11, wherein after performing the first curing step, the method further comprising:
performing an in-mold decoration or an out mold decoration on the composite layer structure, such that the composite layer structure is attached to an outer surface of a workpiece through an adhesive layer, so as to form a decorated molding article; and
performing a second curing step, so as to increase a hardness of the first optical effect layer and the second optical effect layer.

15. A decorated molding article, comprising:
a workpiece; and
a composite layer structure, attached to an outer surface of a workpiece through an adhesive layer, wherein the composite layer structure comprises at least:
a substrate, having a first surface and a second surface opposite to each other;
a first optical effect layer, disposed on the first surface of the substrate; and
a first decorative layer, disposed between the first surface of the substrate and the first optical effect layer, wherein a thickness of the first decorative layer is smaller than a thickness of the first optical effect layer, and the first optical effect layer and the first decorative layer each comprise a protective material, an ink material, and an adhesive material.

16. The decorated molding article as described in claim 15, wherein the protective material comprises polymethyl methacrylate, aliphatic polyurethane acrylate, epoxy acrylate, polyester polyol or a combination thereof; the ink material comprises polyurethane; and the adhering material comprises thermoplastic polyurethane, aromatic urethane acrylate or a combination thereof.

17. The decorated molding article as described in claim 15, wherein the composite layer structure further comprises:
a second optical effect layer, disposed on the second surface of the substrate; and
a second decorative layer, disposed between the second surface of the substrate and the second optical effect layer, wherein a thickness of the second decorative layer is smaller than a thickness of the second optical effect layer.

18. The decorated molding article as described in claim 17, wherein the composite layer structure further comprises:
a first groove, extending from a surface of the first optical effect layer to a direction of the substrate; and
a second groove, extending from a surface of the second optical effect layer to a direction of the substrate.

19. The decorated molding article as described in claim 15, wherein a material of the outer surface of the workpiece comprises plastic, resin, metal, carbon fiber, glass, or a combination thereof.

20. The decorated molding article as described in claim 15, wherein the workpiece comprises an electronic device casing or component and a vehicle casing or component, or a combination thereof, wherein the vehicle casing or component comprises a car interior, a car exterior, a car sign, a car dashboard, a smart key, and an engine start button, or a combination thereof.
